(19) United States
(12) Patent Application Publication
(10) Pub. No.: US 2008/0046539 A1
(43) Pub. Date: Feb. 21, 2008

(54) Method and apparatus for providing internet service to home network

(75) Inventors: Kyung-yong Lee, Suwon-si (KR); Jung-yon Cho, Suwon-si (KR); Young-chul Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/641,814

(22) Filed: Dec. 20, 2006

(30) Foreign Application Priority Data
Aug. 17, 2006 (KR) 10-2006-0077777

(51) Int. Cl. G06F 15/16

(52) U.S. Cl. 709/217; 709/203

(57) ABSTRACT

Provided are a method and an apparatus for providing an Internet service to a home network. The method enables a user to use the Internet service by utilizing a device, in which a web browser is not installed, by representing the Internet service as a virtual home network device, receiving a control request for the virtual home network device from a home network controller, and processing the control request linked with a server providing the Internet service.

### CROSS-REFERENCE TO RELATED PATENT APPLICATION

This application claims priority from Korean Patent Application No. 10-2006-0077777, filed on Aug. 17, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relates to home networking, and more particularly, to providing an Internet service to a home network.

2. Description of Related Art

Currently, home networks installed in a house may be classified into a data network connecting a personal computer (PC) with various peripheral devices and sharing access to the Internet among the computer and the devices, and an audio/video network used for multimedia data transmission among audio/video products.

Recently, networks for controlling electric appliances or security devices have been actively developed and become widespread in the market. As an example, universal plug and play (UPnP) has been proposed as technology capable of being used for home networking among network devices such as various electric appliances, network printers, and Internet gates by using Internet standard technology such as a transmission control protocol/internet protocol (TCP/IP), a hypertext transfer protocol (HTTP), and an extensible markup language (XML) for connecting electric appliances at home so as to form one network.

UPnP has a structure capable of having a role implementing pervasive peer-to-peer network connectivity to a PC, intelligent devices, and wireless devices. UPnP has a distributed and open networking structure in which control and transmission of data anywhere in a house or an office can be performed.

FIG. 1 is a diagram illustrating a related art method of using an Internet service.

Referring to FIG. 1, a user connects to a server on the Internet which provides a service by using a PC, on which a web browser is installed, and requests the internet server for a desired function by using a button or an input window on the web browser.

FIG. 2 is a diagram illustrating a method of controlling a UPnP device in a related art home network.

Referring to FIG. 2, a TV having a built-in UPnP controller downloads desired data from a digital versatile disk (DVD) recorder using an UPnP protocol and reproduces the data. For example, the TV can download a movie from the DVD recorder and reproduce the movie.

In a related art home network using the UPnP, UPnP devices on the home network can be controlled, however, when a TV or the like having a built-in UPnP controller does not include the web browser illustrated in FIG. 1, an Internet service cannot be provided.

### SUMMARY OF THE INVENTION

The present invention provides a method and apparatus for providing an Internet service to a home network, enabling a user to use the Internet service with a device in which a web browser is not installed.

According to an aspect of the present invention, there is provided a method of providing an Internet service to a home network, the method comprising: representing the Internet service as a virtual home network device; receiving a control request for the virtual home network device from a home network controller; and processing the control request linked with a server providing the Internet service.

In the above aspect, the home network may be configured using UPnP.

In addition, the representing the Internet service as a virtual home network device may comprise receiving information required for the representation of the Internet service as the virtual home network device from the server providing the Internet service.

In addition, the information required for the representation of the Internet service as the virtual home network comprises at least one of a content list and information on a status of the home network device.

In addition, the processing the control request may comprise: receiving information required for processing the control request from the server providing the Internet service; and transmitting the received information to the home network controller.

In addition, the Internet service may be an online photo printing service, and the virtual home network device is a virtual printer provided by a plurality of servers providing Internet services.

According to another aspect of the present invention, there is provided an apparatus for providing an Internet service to a home network, the apparatus comprising: a virtualization program which represents the Internet service as a virtual home network device; a home network controller which controls the virtual home network device; and a virtualization device which receives control request from the home network controller and processes the control request linked with a server providing the Internet service.

In the above aspect, the home network may be configured using UPnP.

In addition, the virtualization device may receive information required for the representation of the Internet service as the virtual home network device from the server providing the Internet service.

In addition, the information required for the representation of the Internet service as the virtual home network may comprise at least one of a content list and information on a status of the home network device.

In addition, the virtualization device may receive information required for processing the control request from the server providing the Internet service and transmit the received information to the home network controller.

In addition, the Internet service may be an online photo printing service, and the virtual home network device is a virtual printer provided by a plurality of servers providing Internet services.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a related art method of using an Internet service;

FIG. 2 is a diagram illustrating a method of controlling a UPnP device in a related art home network;

FIG. 3 is a block diagram illustrating an apparatus providing an Internet service to a home network according to an exemplary embodiment of the present invention;

FIG. 4 is a diagram illustrating operations of a virtualization device according to an exemplary embodiment of the present invention;

FIG. 5 is a flowchart illustrating a method of providing an Internet service to a home network according to an exemplary embodiment of the present invention;

FIG. 6 is a diagram illustrating a method of using an internet photo printing service in a home network according to an exemplary embodiment of the present invention; and

FIG. 7 is a flowchart illustrating a method of using an internet photo printing service in a home network according to an exemplary embodiment of the present invention.

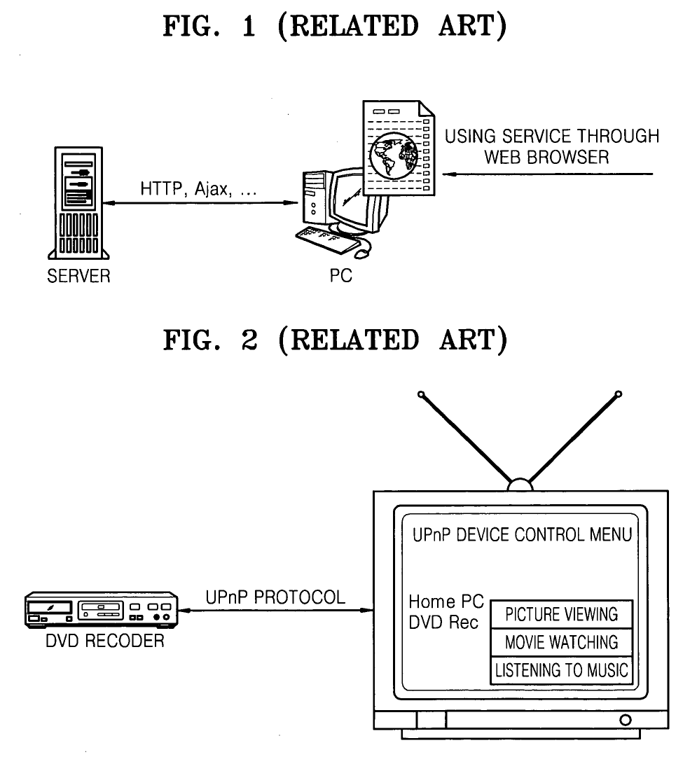

### DETAILED DESCRIPTION OF EXEMPLARY EMBODIMENTS OF THE INVENTION

Now, exemplary embodiments of the present invention will be described in detail with reference to the accompanying drawings.

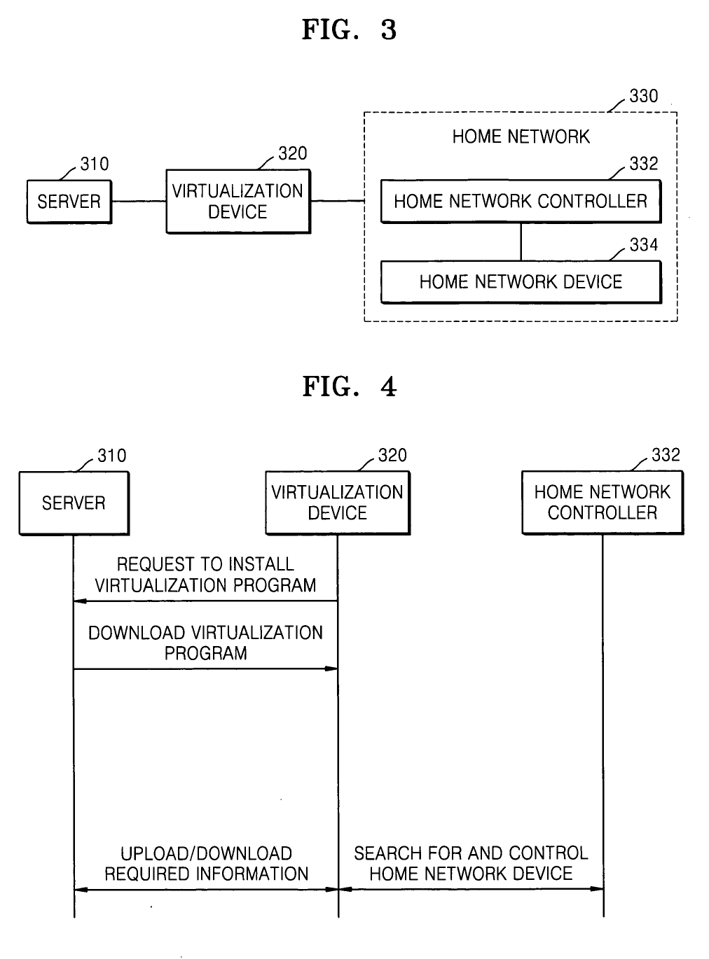

FIG. 3 is a block diagram illustrating an apparatus providing an Internet service to a home network according to an exemplary embodiment of the present invention.

Referring to FIG. 3, the apparatus providing an Internet service in the embodiment includes a server 310, a virtualization device 320, and a home network 330.

The server 310 provides an Internet service.

For example, the Internet service may be a picture and moving picture reproducing service, a photo printing service, etc., and may include various services.

The virtualization device 320, on which a virtualization program is installed, receives a control request from a home network controller and performs the control request linked with a server providing the Internet service. At this time, the virtualization device 320 may use a dedicated communication protocol such as TCP/IP for communication with the server 310, and may use the UPnP protocol or the like, for communication with the home network 330. The communication protocols are not limited to TCP/IP and UPnP protocols, and various communication protocols may be used according to an exemplary embodiment of the present invention.

In addition, the virtualization device 320 receives required information from the server 310 on the Internet and transmits the information to the home network 330, when the information is required for processing the control request. Here, the information required for processing the control request is, for example, a file containing content of a picture when the user selects to view the picture, or a file containing content of a movie when the user selects to reproduce the movie.

FIG. 4 is a diagram illustrating operations of a virtualization device according to an exemplary embodiment of the present invention. For convenience of explanation, only a home network controller 332 in a home network 330 is illustrated.

A virtualization device 320 requests a server 310 to install a virtualization program and downloads the virtualization program from the server 310. The virtualization device 320 represents an Internet service, which the server 310 provides, as a virtual home network device by executing the virtualization program, after installing the virtualization program. In other words, the virtualization program functions to represent the Internet service as the virtual home network device.

The virtualization program may be programmed in various programming languages such as active server page (ASP), hypertext preprocessor (PHP), java server page (JSP), common gateway interface (CGI), and practical extraction and report Language (PERL).

The virtualization device 320 may receive information, which is required for the representation of the Internet service as the virtual home network device, from the server 310. For example, the information may be a content list or information on the status of the virtual home network device. Here, the content list may be a movie list or a music list, and the information on the status of the virtual home network device may be the operational status of a printer or various added functions which the printer can provide when the virtual home network device is the printer.

At this time, when a user selects content from the content list, for example, a movie in the movie list, the home network controller 332 requests the virtualization device 320 for controlling for the movie. Then, when there is information required for processing the control request, the virtualization device 320 receives the information from the server providing the Internet service and transmits the information to the home network. As explained above, when the user selects to watch a movie, the required information for processing the control request is a file containing the content of the movie.

Referring to FIG. 3, the home network 330 includes a home network controller 332 and at least one home network device 334.

The home network controller 332 searches for the home network device 334 and virtual home network devices (not shown), and finds and controls the functions of the devices, according to a key input from the user. In this case, the home network controller 332 may be built into a TV or a PC and used by a user.

The home network device 334 is controlled by the home network controller 332 as to whether the home network devices are operated, etc. For example, the home network device 334 may be a DVD player, an audio device, or a printer, and other electric appliances may be further included.

Here, the home network 330 may be implemented by using UPnP.

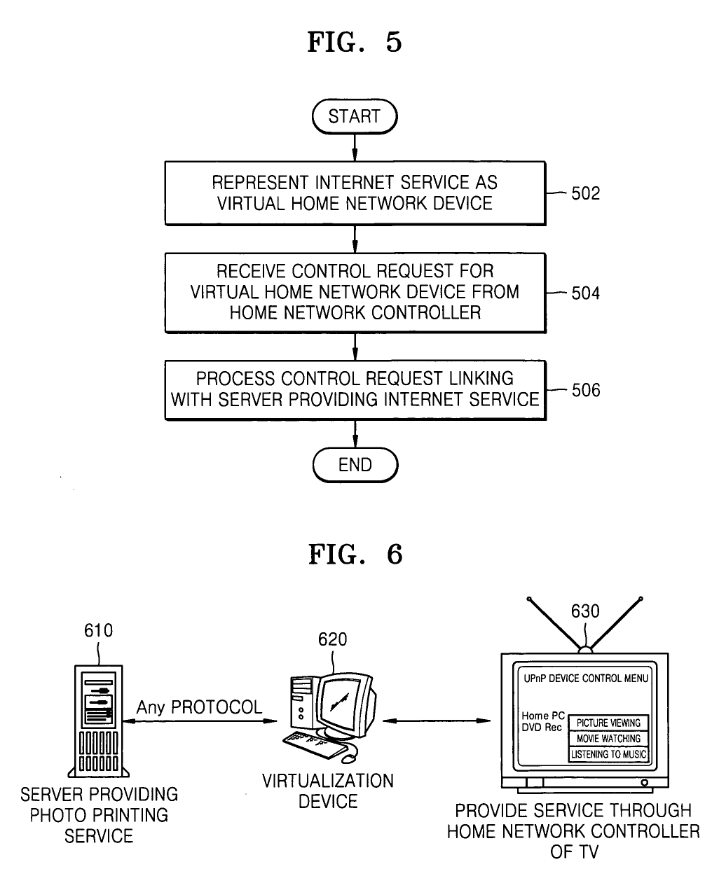

FIG. 5 is a flowchart illustrating a method of providing an Internet service to a home network according to an exemplary embodiment of the present invention.

At first, the Internet service is represented as a virtual home network device (Operation 502).

As explained above, the Internet service is represented as the virtual home network device by installing and executing the virtualization program on a virtualization device. In addition, the virtualization device may receive information required for the representation of the Internet service as the virtual home network device from a server.

A control request for the virtual home network device is received from a home network controller (Operation 504).

Here, the control request includes a request for reproducing a picture, a movie, or music, when reproduction of the picture, the movie, or the music is performed.

The control request is process linked with a server providing the Internet service (Operation 506).

As described above, when there is information required for processing the control request, the virtualization device receives the information from the server providing the Internet service and transmits the information to the home network.

Hereinafter, a method of using an internet photo printing service in a home network using a method of providing an Internet service to a home network according to an exemplary embodiment of the present invention will now be explained.

FIG. 6 is a diagram illustrating a method of using an internet photo printing service in a home network according to an exemplary embodiment of the present invention.

Referring to FIG. 6, on a screen of a TV 630 having a built-in home network controller, a menu including options of viewing a picture, watching a movie, and listening to music is displayed. At this time, a camera, a DVD player, a music playing device, etc. may be connected to the TV 630 on a home network for performing the operations of viewing a picture, watching a movie, and listening to music.

However, an exemplary embodiment of the present invention provides a method of using a service on a home network, even for a case when a device providing the service is located outside the home network, along with a case where the device providing the service is located in the home network. In other words, an embodiment of the present invention provides a method of using a service in a home network which is provided by a server on the Internet.

For example, referring to FIG. 6, although a server 610 providing a photo printing service is not located in the home network, the photo printing service which the server 610 provides can be used in the home network, when a user views a picture by selecting the option of viewing a picture on a screen of a TV 630 and selects photo printing if there is a picture the user wants to print.

At this time, the server 610 providing the photo printing service may include a plurality of servers providing Internet services. In other words, the service may be configured so that a user can select one of a plurality of Internet service providers, besides selecting one of the services that a single service provider provides. When the user selects an Internet service provider, a printer provided by the server 610 providing the Internet service is configured as a virtual home network device. When the virtual home network device is configured, the user can output a photo using a printer on the Internet through a system, such as the TV 630, having a built-in home network controller.

Hereinafter, exemplary embodiments in which billing and delivery service is added to a photo printing service on the Internet according to an exemplary embodiment of the present invention will now be explained.

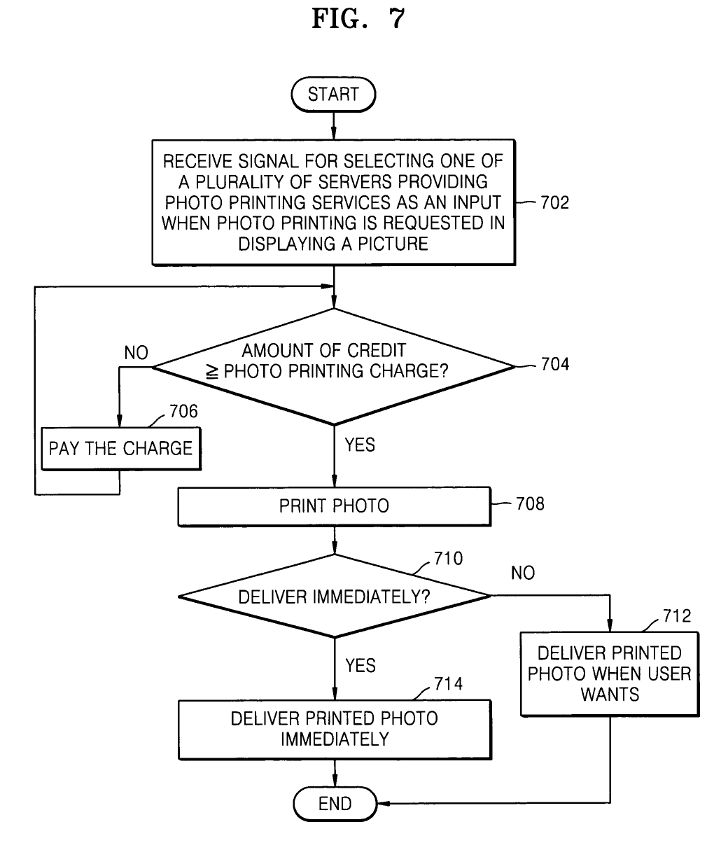

FIG. 7 is a flowchart illustrating a method of using an internet photo printing service in a home network according to an exemplary embodiment of the present invention.

A signal for selecting one of a plurality of servers providing photo printing services is received as an input, when photo printing is requested while displaying a picture (Operation 702).

When one of the plurality of servers is selected, a printer which the selected server provides is indicated as a virtual home network device.

An amount of a user's credit stored in the server is compared with a charge required for photo printing (Operation 704).

When the amount of the user's credit is below the charge required for the photo printing, the required amount is paid by the user (706).

At this time, the payment may be made by various methods such as a credit card, an automatic response system (ARS), a cellular phone, or an account transfer.

On the other hand, when the user's credit is above the required charge for the photo printing, the photo is printed (Operation 708).

Next, it is determined whether the printed photo will be immediately delivered (Operation 710).

When immediate delivery is not selected, the printed photo is kept by the Internet service provider and delivered at a time when the user wants (Operation 712).

On the other hand, when immediate delivery is selected, the printed photo is delivered to the user immediately (Operation 714).

The above embodiments of the present invention can be written as computer programs and can be implemented in general-use digital computers that execute the programs using a computer readable recording medium. Examples of the computer readable recording medium include magnetic storage media, e.g. ROM, floppy disks, hard disks, optical recording media, e.g. CD-ROMs or DVDs, and storage media such as carrier waves, e.g. transmission through the Internet.

According to the exemplary embodiments of the present invention, an Internet service can be provided using a device in which a web browser is not installed.

While the present invention has been particularly shown and described with reference to exemplary embodiments thereof, it will be understood by those of ordinary skill in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method of providing an Internet service to a home network, the method comprising:
representing the Internet service as a virtual home network device;
receiving a control request for the virtual home network device from a home network controller; and
processing the control request linked with a server providing the Internet service.

2. The method of claim 1, wherein the home network is configured using universal plug and play (UPnP).

3. The method of claim 1, wherein the representing the Internet service as a virtual home network device comprises receiving information required for the representation of the Internet service as the virtual home network device from the server providing the Internet service.

4. The method of claim 3, wherein the information required for the representation of the Internet service as the virtual home network comprises at least one of a content list and information on a status of the home network device.

5. The method of claim 1, wherein the processing the control request comprises:
receiving information required for processing the control request from the server providing the Internet service; and
transmitting the received information to the home network controller.

6. The method of claim 1, wherein the Internet service is an online photo printing service, and the virtual home network device is a virtual printer provided by a plurality of servers providing Internet services.

7. An apparatus for providing an Internet service to a home network, the apparatus comprising:
a virtualization program which represents the Internet service as a virtual home network device;
a home network controller which controls the virtual home network device; and
a virtualization device which receives a control request from the home network controller and processes the control request linked with a server providing the Internet service.

8. The apparatus of claim 7, wherein the virtualization program is installed in the virtualization device.

9. The apparatus of claim 7, wherein the home network is configured using universal plug and play (UPnP).

10. The apparatus of claim 7, wherein the virtualization device receives information required for the representation of the Internet service as the virtual home network device from the server providing the Internet service.

11. The apparatus of claim 10, wherein the information required for the representation of the Internet service as the virtual home network comprises at least one of a content list and information on a status of the home network device.

12. The apparatus of claim 7, wherein the virtualization device receives information required for processing the control request from the server providing the Internet service and transmits the received information to the home network controller.

13. The apparatus of claim 7, wherein the Internet service is an online photo printing service, and the virtual home network device is a virtual printer provided by a plurality of servers providing Internet services.

14. An apparatus for providing an Internet service to a home network, the apparatus comprising:
a virtualization device which represents the Internet service as a virtual home network device; and
a home network controller which controls the virtual home network device,
wherein the virtualization device receives a control request from the home network controller and processes the control request linked with a server providing the Internet service.

15. The apparatus of claim 14, wherein the virtualization device requests the server to install a virtualization program, downloads the virtualization program from the server, and executes the virtualization program to represent the Internet service as the virtual home network device.

16. A computer readable recording medium storing a computer program for performing a method of providing an Internet service to a home network, the method comprising:
representing the Internet service as a virtual home network device;
receiving a control request for the virtual home network device from a home network controller; and
processing the control request linked with a server providing the Internet service.
